(19) United States
(12) Patent Application Publication
(10) Pub. No.: US 2002/0140805 A1
(43) Pub. Date: Oct. 3, 2002

(54) Television program selection system

(75) Inventors: Srinivas Gutta, Buchanan, NY (US); Kaushal Kurapati, Yorktown Heights, NY (US); Miroslav Trajkovic, Ossining, NY (US)

Correspondence Address: Michael E. Marion, Corporate Patent Counsel, U.S. Philips Corporation, 580 White Plains Road, Tarrytown, NY, 10591, US

(73) Assignee: Koninklijke Philips Electronics N.V.

(21) Appl. No.: 09/819,278

(22) Filed: Mar. 28, 2001

(51) Int. Cl. H04N 5/445

(52) U.S. Cl. 348/40; 725/41

(57) ABSTRACT

A television program selection system and method that utilize key frame images of each program. The key frame images are extracted from the recorded show as the program progresses. This continuum of key frame images provides the viewer with a condensed story line and scope of each program, thus allowing the viewer to make an intelligent choice of the programs that he or she intends to record and/or watch.

### BACKGROUND OF THE INVENTION

The present invention relates to television program selecting systems, wherein television viewers are presented with information of available programs and then allowed to choose those programs that they believe, in most likelihood, will be a source of good entertainment.

1. Field of the Invention

In the past, television viewers made choices about the programs that they preferred to watch by consulting TV program listings, newspaper television guides, and other written sources of information. At best, this type of information was cryptic and limited, in terms of informing the general public about the content of specific films, particular sitcoms and other programming. Even in those cases where a full-page description of a film's content was available, as in cases of special television presentations, many viewers were often disappointed. This was due in part to the inherent coldness of the written page. Written narrative alone can never adequately convey the intensity, action, and emotion that a film will invoke in the psyche of each individual.

The number of television channels has exploded, and programs that are available to the user have greatly increased. It appears that this trend will continue into the near future. As a result, there is an increasing need for more selectivity in choosing a program of entertainment.

In addition to the explosion in programs, machines like TiVo that allow the recordation of thirty-six hours of television time, have escalated the need for making more informative program choices.

The present invention reflects the discovery that textual description is often inadequate to provide a television viewer with enough information to make an informed program selection.

The current invention is a television program selection system, wherein each program choice is displayed on a screen as a key frame that has been extracted from the taped show. The key frames are meant to replace the need for description, but could be used in conjunction with brief messages to enhance the information being presented. The key frames can be shown in sequential mosaic form, or as a sequence of flashing images, not unlike coming attractions in movies. The sequence of key frame images represents a continuum of the show as it progresses, so that one quickly gets an informed impression of the plot, scope and substance of the program. The key frames may themselves contain a highlighted frame that exemplifies the theme.

2. Discussion of Related Art

In U.S. Pat. No. 5,822,014, a method of program selection is illustrated wherein television shows are displayed by a mosaic of images. The mosaic is divided into nine rectangles, each showing the channel transmission logo. The system provides viewer flexibility by providing the ability to move among images of the mosaic.

In Japanese Patent Disclosure No. JP 08307728A, a method is depicted for displaying programs by pre-selected images that are genre based. For example, a baseball game would be represented by a player holding a bat. Unlike the present invention, however, the images are not key frames, nor are they representative of the story line or progress of the show. In addition to displaying images on the television, this aforementioned disclosure contemplates displaying these images upon a handheld remote device.

In U.S. Pat. No. 6,005,562, a method is illustrated for displaying television programs with reduced images and a synopsis of the content of the program. Specifically, upon reception, the EPG data is separated from the received program data, and the images of reduced, less than normal size representations of EPG data are displayed.

### SUMMARY OF THE INVENTION

In accordance with the present invention, a method and system are illustrated wherein selective television program choices can be made via a display of key frame information. Key frames of a particular show are extracted during the progress of the show, in order to provide a condensed continuum of the story line of the program. The television program selection system uses the key frames that have been extracted from the taped show, in order to replace the need for description. However, it is contemplated that the key frame images can be used in conjunction with brief messages to enhance the information being presented and/or in conjunction with sound bites.

The key frames can be shown in sequential form, such as a sequence of flashing images, not unlike the coming attractions of movies. The sequence of key frame images represents a continuum of the plot, scope and substance of the program. The key frames may themselves contain a highlighted frame that exemplifies the theme, such as a frame that is illustrated in a single color.

It is an object of the present invention to provide an improved television program selection system that is highly indicative of the scope, plot, and character of the show.

It is another object of this invention to provide a television program selection system that features key frame information in sequential form, in order to allow the viewer to follow the story line or plot of the show in a condensed continuum.

### BRIEF DESCRIPTION OF THE DRAWINGS

A complete understanding of the present invention may be obtained by reference to the accompanying drawings, when considered in conjunction with the subsequent detailed description, in which:

FIG. 1 illustrates a block diagram of a prior art television program selection grid; and

FIG. 2 depicts a block diagram of the television program selection grid in accordance with the present invention.

For purposes of brevity and clarity, like components and elements of the apparatus of this invention, will bear the same designations or numbering throughout the figures.

### DESCRIPTION OF THE PREFERRED EMBODIMENT

Generally speaking, the present invention features a television program selection system and method that utilize key frame images of each program. The key frames are extracted from the recorded show as the program progresses. This continuum of images provides the viewer with a condensed story line and scope of each program, thus allowing the viewer to make an intelligent choice of the programs that he or she intends to record and/or watch.

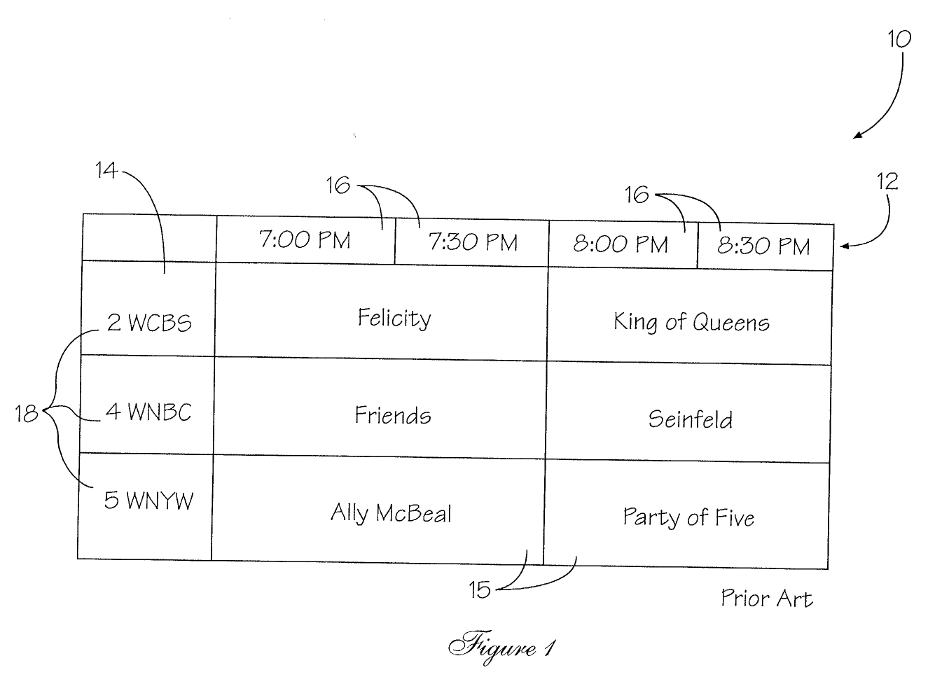

Now referring to FIG. 1, a block diagram is illustrated of a typical, prior art, television program selection grid 10. As will be observed, the television program selection grid 10 is encompassed by a time axis 12 displayed on top of the grid 10, and a television channel axis 14 displayed on the left hand side of the grid 10. Individual time slots 16 are displayed along the x-axis or time axis 12. Individual channel slots 18 are displayed along the y-axis or television channel axis 14. The grid 10 comprises a plurality of program windows 15 containing textual information regarding the program available for the time and channel slots. This type of textual selection grid 10 does not provide program content, so that a television viewer cannot make an intelligent choice as to which program he or she would prefer to watch and/or record.

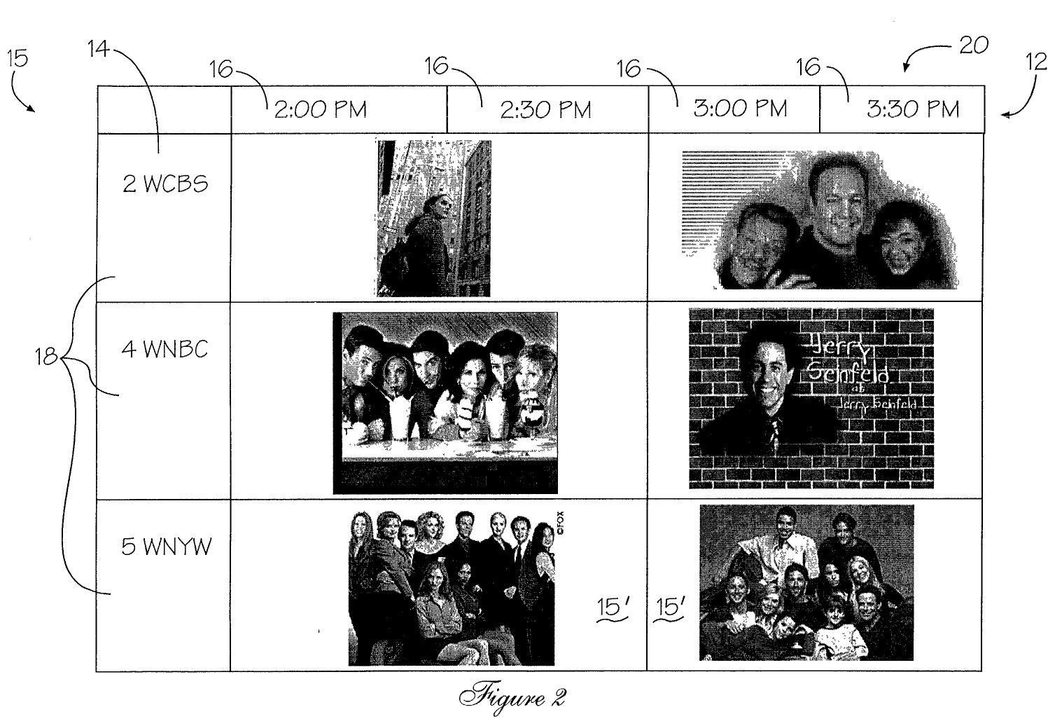

Referring to FIG. 2, a block diagram is shown of the television program selection grid 20 in accordance with the current invention. Like the prior art grid 10, the inventive grid 20 comprises a time axis 12 having time slots 16, and a channel axis 14 comprising channel slots 18. Unlike the prior art grid 10, however, the grid 20 of this invention comprises show windows 15′ containing image information with respect to each slotted program. The images provide a brief glimpse of the intended program. The television viewer would be instructed to use his remote control wand (not shown) or mouse (if television is being broadcast upon a computer monitor) to click upon the window 15 of grid 10 to bring or invoke into view new image grid 20.

A television viewer interested in any particular program represented by the show window 15′ would be instructed by menu text, machine instructions, or otherwise, to use his or her remote control wand or mouse to select the particular window 15′ of interest. In so doing, the window will begin to display a sequential series of key frame images of the program. The sequential, key frame images relate to the progress of the show, so that the viewer will be provided with a series of sequential key frames of that particular show. The key frames are extracted from the recorded show, as the program progresses. This continuum of images provides the viewer with a condensed story line and scope of each program, thus allowing the viewer to make an intelligent choice of the programs that he or she intends to record and/or watch. One such key frame may be highlighted, such as by presenting that image in a single color or with a bright border. The highlighted key frame would be most representative of the theme of the entire program. Each key frame image may also be accompanied by a brief textual message and/or sound bites, which will further enhance the viewer's understanding.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A television program selection system, comprising: a grid of television programs slotted for a particular time and channel, said grid containing key frame images of each program; and means to select the slotted program to reveal a sequential showing of said key frame images.

2. The television program selection system in accordance with claim 1, wherein said key frame images are invoked in a sequence following the story line or progress of the program.

3. The television program selection system in accordance with claim 1, wherein one of said key frame images is highlighted.

4. The television program selection system in accordance with claim 1, wherein said key frame images comprise at least one sound byte.

5. The television program selection system in accordance with claim 1, wherein said key frame images comprise a textual message.

6. The television program selection system in accordance with claim 3, wherein said highlighted key frame image is most indicative of the theme of the program.

7. The television program selection system in accordance with claim 3, wherein said highlighted key frame image comprises a single color.

8. The television program selection system in accordance with claim 3, wherein said highlighted key frame image comprises a bright border.

9. The television program selection system in accordance with claim 3, wherein said highlighted key frame image comprises a sound bite.

10. A method of selecting a preferred television program from a plurality of television programs, comprising the steps of:
a) choosing a specific program from a display of textually described programs; and
b) displaying said specific program as a sequence of key frame images.

11. The method of selecting a preferred television program in accordance with claim 10, wherein said display of key frame images in accordance with step (b) sequentially follows the story line or progress of said specific program and at least one of said key frame images is highlighted.

12. The television program selection method in accordance with claim 10, wherein said key frame images comprise at least one sound bite.

13. The television program selection method in accordance with claim 10, wherein said key frame images comprise a textual message.

14. The television program selection method in accordance with claim 11, wherein said at least one highlighted key frame image is most indicative of the theme of the program.

15. The television program selection method in accordance with claim 11, wherein said at least one highlighted key frame image comprises a single color.

16. The television program selection method in accordance with claim 11, wherein said at least one highlighted key frame image comprises a bright border.

17. The television program selection method in accordance with claim 11, wherein said at least one highlighted key frame image comprises a sound bite.

18. A television program selection system, comprising a grid of television programs slotted for a particular time and channel, said grid displaying key frame images of each television program selected by a television viewer.

19. The television program selection system in accordance with claim 18, wherein each selected television program comprises a sound bite.

20. The television program selection system in accordance with claim 18, wherein said grid displays a sequence of key frame images for each program and further wherein said sequence follows the progress of that particular program.
